(19) United States
(12) Patent Application Publication
(10) Pub. No.: US 2006/0150646 A1
(43) Pub. Date: Jul. 13, 2006

(54) Method of operation and regulation of a vapour compression system

(76) Inventors: Kare Aflekt, Trondheim (NO); Armin Hafner, Tronheim (NO); Arne Jakobsen, Trondheim (NO); Petter Neksa, Trondheim (NO); Jostein Pettersen, Trondheim (NO); Havard Rekstad, Trondheim (NO); Geir Skaugen, Trondheim (NO); Trond Andresen, Trondheim (NO); Espen Tondell, Trondheim (NO); Munan Elgsaether, Trondheim (NO)

Correspondence Address: WENDEROTH, LIND & PONACK, L.L.P., 2033 K STREET N. W., SUITE 800, WASHINGTON, DC, 20006-1021, US

(21) Appl. No.: 10/539,611

(22) PCT Filed: Dec. 17, 2003
(86) PCT No.: PCT/NO03/00425

§ 371 Date: Nov. 7, 2005

(30) Foreign Application Priority Data
Dec. 23, 2002 (NO) 20026232

(51) Int. Cl. G05D 23/32

(52) U.S. Cl. 62/157

(57) ABSTRACT

A compression refrigeration system includes a compressor (1), a heat rejector (2), expansion means (3) and a heat absorber (4) connected in a closed circulation circuit that may operate with supercritical high-side pressure.

### FIELD OF INVENTION

The present invention relates to compression refrigeration system including a compressor, a heat rejector, an expansion means and a heat absorber connected in a closed circulation circuit that may operate with supercritical high-side pressure, using carbon dioxide or a mixture containing carbon dioxide as the refrigerant in the system.

### DESCRIPTION OF PRIOR ART AND BACKGROUND OF THE INVENTION

Conventional vapour compression systems reject heat by condensation of the refrigerant at subcritical pressure given by the saturation pressure at the given temperature. When using a refrigerant with low critical temperature, for instance CO₂, the pressure at heat rejection will be supercritical if the temperature of the heat sink is high, for instance higher than the critical temperature of the refrigerant, in order to obtain efficient operation of the system. The cycle of operation will then be transcritical, for instance as known from WO 90/07683. Temperature and the high-pressure side will be independent variables contrary to conventional systems.

WO 94/14016 and WO 97/27437 both describe a simple circuit for realising such a system, in basis comprising a compressor, a heat rejector, an expansion means and an evaporator connected in a closed circuit. CO₂ is the preferred refrigerant for both of them.

The system coefficient of performance (COP) for trans-critical vapour compression systems is strongly affected by the level of the high side pressure. This is thoroughly explained by Pettersen & Skaugen (1994), who also presents a mathematical expression for the optimum pressure. Based on the fact that the high side pressure is independent from temperature, high side pressure can be controlled in order to achieve optimum energy efficiency. The next step is to determine optimum pressure for given operating conditions.

Several publications and patents are published, which suggests different strategies to determine the optimum high side pressure. Inokuty (1922) published a graphic method already in 1922, but it is not applicable for the present digital controllers.

EP 0 604 417 B1 describe how different signals can be used as steering parameter for the high side pressure. A suitable signal is the heat rejector refrigerant outlet temperature. The relation between optimum high side pressure and the signal temperature is calculated in advance or measured. Densopatent describes more or less an analogous strategy. Different signals are used as input parameter to a controller, which based on the signals regulates the pressure to a predetermined level.

Among others, Liao & Jakobsen (1998) presented an equation, which calculates optimum pressure from theoretical input. The equation does not take into account practical aspects which may affect the optimum pressure sicnificantly.

Most methods for optimum pressure determination described above, has a theoretical approach. This means that they are not able to compensate for practical aspects like varying operating conditions, influence of oil in the system, . . . Optimum pressure will then most probably be different from the calculated one. There is also a risk for a “wind up” and lack of control. The temperature signal gives a feedback to the controller, which adjust the pressure with some delay. If conditions change quit rapidly, the controller will never establish a constant pressure, and cooling capacity will vary.

As explained above, it is a possibility to run tests and measure optimum high side pressure relations. But this is time consuming, expensive. Furthermore, it is hard, if not impossible, to cover all operating conditions. And the measurements has to be performed for all new designs.

### SUMMARY OF THE INVENTION

A major object of the present invention is to make a simple, efficient system that avoids the aforementioned shortcomings and disadvantages.

The invention is characterized by the features as defined in the accompanying independent claim 1.

Advantageous features of the invention are further defined in the accompanying independent claims 2-8.

The present invention is based on the system described above, comprising at least a compressor, a heat rejector, an expansion means and a heat absorber. It is a new and novel method for optimum operation of such a system with respect to energy efficiency.

When operating conditions change, the controller in the trans-critical vapour compression system can perform a perturbation of the high side pressure and thereby establish a correlation between the pressure and the energy efficiency, or a suitable parameter reflecting the energy efficiency. A relation between high side pressure and energy efficiency can then easily be mapped, and optimum pressure determined and used until operating conditions change. This is a simple method which will work for all designs of trans-critical vapour compression systems. No initial measurements have to be made, and practical aspects will be accounted for on site.

### BRIEF DESCRIPTION OF THE DRAWINGS

The invention will be further described in the following by way of examples only and with reference to the drawings in which,

FIG. 1 illustrates a simple circuit for a vapour compression system.

FIG. 2 shows a temperature entropy diagram for carbon dioxide with an example of a typical trans-critical cycle.

FIG. 3 shows a schematic diagram showing the principle of optimum high side pressure determination. Temperature approach is used as COP reflecting parameter in the figure.

### DETAILED DESCRIPTION OF THE INVENTION

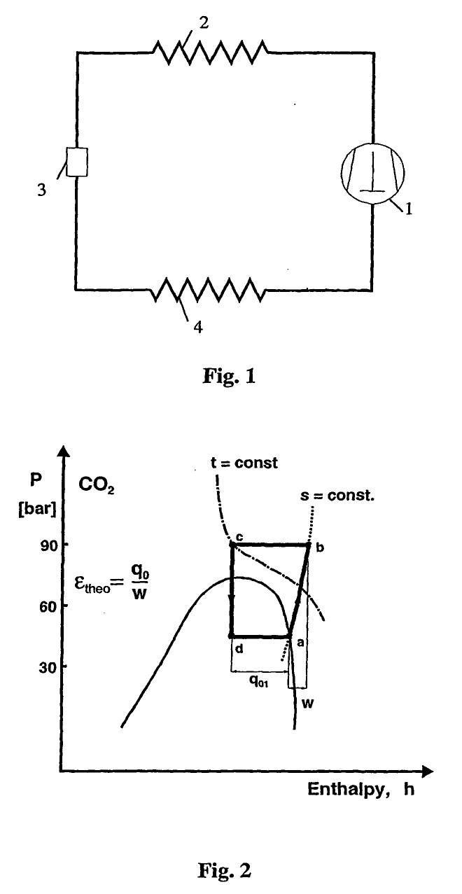

FIG. 1 illustrates a conventional vapour compression system comprising a compressor 1, a heat rejector 2, an expansion means 3 and a heat absorber 4 connected in a closed circulation system.

FIG. 2 shows a trans-critical CO₂ cycle in a temperature entropy diagram. The compression process is indicated as isentropic from state a to b. The refrigerant exit temperature out of the heat rejector c is regarded as constant. Specific work, specific cooling capacity and coefficient of performance are explained in the figure.

As mentioned above, there is a mathematical expression for high optimum high side pressure in a trans-critical vapour compression system. The expression is as follows:

$${( \frac{\partial {h}_{c}}{\partial p} )}_{T} = - {ɛ ( \frac{\partial {h}_{b}}{\partial p} )}_{s}$$

The optimum pressure is achieved when the marginal increase of capacity (change of h_{c} at constant temperature) equals ε times the marginal increase in work (change of h_{b} at constant entropy).

Perturbation of the high side pressure, is in principle a practical approach to use the equation above. By mapping the energy efficiency, or a parameter which reflects the energy efficiency, as function of high side pressure, it is possible to establish the point where the marginal increase of capacity equals ε times the marginal increase in work.

Various parameters can be used as reflection for the energy efficiency.

### EXAMPLE 1

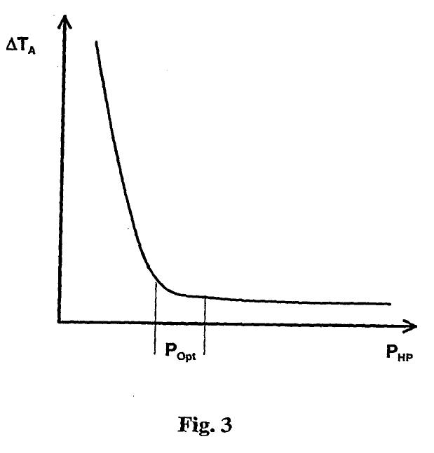

The temperature difference between refrigerant and heat sink at the cold end of the heat rejector 4, is often denoted as “temperature approach” for a trans-critical cycle. There is a correlation between high side pressure and the temperature approach. An increase of the high side pressure will lead to a reduction of temperature approach. The high side pressure can favourably be increased until a further increase does not lead to a significant reduction of temperature approach. At this point, optimum high side pressure is then in practice established, and the system can be operated at optimum conditions, maximizing the system COP. This principle is illustrated in FIG. 3.

A perturbation of the high side pressure will produce a relation as indicated in FIG. 3. When operating conditions change, or for other reasons, a new perturbation can be made and a new updated relation established. In this way, the trans-critical system will always be able to operate close to optimum conditions.

### EXAMPLE 2

Instead of using the temperature approach, it is an option to use the gas cooler outlet temperature as parameter for reflection of energy efficiency.

### EXAMPLE 3

By online measurements of system pressures and temperatures, it is possible to automatically calculate the enthalpies for a trans-critical cycle at the points 1 to 4 indicated in FIG. 2, if the refrigerant properties can be provided from property a library. The enthalpies can be used for calculation of the system coefficient of performance. A perturbation of the high side pressure will then produce a relation between COP and the high side pressure directly.

If COP is used as steering parameter, the optimum high side pressure will be established directly. If a COP reflecting parameter is used, an exact measure for the “marginal effect” on the parameter has to be quantified. This measure can however easily be estimated. Another possibility is to increase pressure until the parameter reaches a predetermined level.

1-8. (canceled)

9. A compression refrigeration system including at least a compressor (1), a heat rejector (2), an expansion means (3) and a heat absorber (4) connected in a closed circulation circuit that may operate with supercritical high-side pressure, wherein an online estimation of coefficient of performance (COP), or a parameter reflecting the COP, can be used as a signal for optimum regulation and operation of the compression refrigeration system.

10. System according to claim 9, wherein carbon dioxide or a refrigerant mixture containing carbon dioxide is applied as the refrigerant in the system.

11. System according to claim 9, wherein the regulation system may vary pressure on the high pressure side in order to map the COP or the COP reflecting parameter as function of pressure for a given operation condition.

12. System according to claim 9, wherein the temperature difference between the refrigerant and heat sink at the cold end (temperature approach) can be used as a signal for optimum regulation and operation of the compression refrigeration system.

13. System according to claim 9, wherein the pressure on the high pressure side of the system can be increased until the increase has marginal effect on the temperature approach.

14. System according to claim 9, wherein the pressure on the high pressure side of the system can be increased until temperature approach is equal or lower than a predetermined level.

15. System according to claim 14, wherein the predetermined level may vary with varying operation conditions.

16. System according to claim 9, wherein the heat rejector outlet temperature can be used as COP reflecting parameter.
